(19) United States
(12) Patent Application Publication
(10) Pub. No.: US 2020/0248795 A1
(43) Pub. Date: Aug. 6, 2020

(54) DEVICE AND METHOD FOR DETERMINING A POSITION OF AN ACTUATING ELEMENT FOR A TRANSMISSION OF A VEHICLE AND SYSTEM FOR EFFECTING SHIFTING OPERATIONS OF A TRANSMISSION OF A VEHICLE

(71) Applicant: ZF Friedrichshafen AG, Friedrichshafen (DE)

(72) Inventor: Andreas Hoffmann, Bramsche (DE)

(73) Assignee: ZF Friedrichshafen AG, Friedrichshafen (DE)

(21) Appl. No.: 16/487,967

(22) PCT Filed: Jan. 22, 2018
(86) PCT No.: PCT/EP2018/051427

§ 371 Date: Aug. 22, 2019

(30) Foreign Application Priority Data
Feb. 22, 2017 (DE) 10 2017 202 833.5

(51) Int. Cl. F16H 59/10; G01D 5/14; F16H 59/04; F16H 61/12

(52) U.S. Cl. CPC F16H 59/105; F16H 61/12; F16H 59/044; G01D 5/145

(57) ABSTRACT

A system coupled to a vehicle transmission may include an actuating element for initiating a shift of the vehicle transmission, where the actuating element includes a magnetic transmitter, and where the actuating element is movable between a plurality of positions. A 3D Hall sensor may be coupled to a semiconductor chip, where the 3D Hall sensor is configured to detect a position of the actuating element by cooperating with the magnetic transmitter. At least one single-axis Hall sensor may also be included, where the single-axis Hall sensor is also configured to detect the position of the actuating element by cooperating with the magnetic transmitter.

### RELATED APPLICATIONS

This application is a filing under 35 U.S.C. § 371 of International Patent Application PCT/EP2018/051427, filed Jan. 22, 2018, and claiming priority to German Patent Application 10 2017 202 833.5, filed Feb. 22, 2017. All applications listed in this paragraph are hereby incorporated by reference in their entireties.

### TECHNICAL FIELD

The present invention relates to a device for determining a position of an actuating element for a transmission of a vehicle, a system for effecting shifting procedures in a transmission of a vehicle, and a method for determining a position of an actuating element for a transmission in a vehicle.

### BACKGROUND

Shifting positions of gearshift levers or the like for automatic transmissions can be detected in vehicles by means of magnetic field sensors, for example. For safety reasons, such magnetic field sensors can contain, in particular, 3D Hall sensors with two semiconductor chips, so-called double die 3D Hall sensors, or the like.

A driver intention detection sensor system is described in DE 10 2015 103 998 A1 in which Hall sensors or inductive sensors can be used for determining the position of the gearshift lever.

Based on this, the present invention results in an improved device for determining a position of an actuating element for a transmission in a vehicle, an improved system for effecting shifting procedures in a transmission of a vehicle, and an improved method for determining a position of an actuating element for a transmission in a vehicle.

### BRIEF DESCRIPTION OF THE DRAWINGS

The invention shall be explained in greater detail based on the attached drawings. Therein:

FIG. 1 shows a schematic illustration of a system according to an exemplary embodiment.

FIG. 2 shows a flow chart for a method for determining a position according to an exemplary embodiment.

FIG. 3 shows a schematic illustration of a system according to an exemplary embodiment.

### DETAILED DESCRIPTION

According to embodiments of the present invention, a first magnetic field sensor in the form of a 3D Hall sensor on a single semiconductor chip, and a second magnetic field sensor in the form of a single-axis Hall sensor can be used in particular for detecting the intention of a driver regarding a driving mode or a gear setting for a transmission in a vehicle. By way of example, there is therefore no need for a magnetic field sensor in the form of a 3D Hall sensor on two semiconductor chips.

Advantageously, embodiments of the present invention a sensor system in particular in the form of a sensor system conforming to ASIL-B standards (ASIL: Automotive Safety Integrity Level) can be used for detecting the driver's intention with a 3D Hall sensor on a single semiconductor chip (single die), and one or more, e.g. digital, single-axis Hall sensors. Production costs, in particular material costs, can be reduced by using a single die 3D Hall sensor, in contrast to a double die 3D Hall sensor. As a result, digital Hall sensors or 3D Hall sensors on a single semiconductor chip can be used for the sensor system to detect the driver's intention, in particular with an automatic transmission in a vehicle, in order to obtain a sensor system conforming to ASIL-B standards in accordance with ISO 26262. ASIL-B conformity for producing a gearshift lever for a vehicle transmission can be obtained in particular without a 3D Hall double die sensor, wherein errors, e.g. “stuck at” can be reliably detected in 3D Hall sensors. It is also possible to determine whether the sensor is defective, or whether the driver has not moved the gearshift lever, or there is no intention to do so on the part of the driver.

A device for determining a position of an actuating element for a transmission in a vehicle, wherein the actuating element contains a magnetic transmitter, wherein the actuating element can be moved by a driver of the vehicle to different positions in order to effect shifting procedures in the transmission, comprises at least the following features:

a first magnetic field sensor in the form of a 3D Hall sensor on a semiconductor chip, wherein the first magnetic field sensor is configured to detect every position of the actuating element using the magnetic transmitter; and

at least one second magnetic field sensor in the form of a single-axis Hall sensor, wherein the at least one second magnetic field sensor is configured to detect at least one position of the actuating element using the magnetic transmitter.

The vehicle can be a motor vehicle, e.g. a land vehicle, in particular a passenger car or a utility vehicle. The transmission can be in the form of a manual transmission, an at least partially automatic transmission, an automatic transmission, etc. The first magnetic field sensor can be a sensor other than a 3D Hall sensor with two semiconductor chips, or a so-called double die 3D Hall sensor. The first magnetic field can be formed on, and/or in a single semiconductor chip. The magnetic transmitter can move with the actuating element when it is actuated. As a result, a position of the actuating element can be assigned and/or correspond to a position of the magnetic transmitter. When detecting a position of the actuating element using the magnetic transmitter, the size, or a change in the size of a magnetic field can be detected. Optionally, the first magnetic field sensor or the second magnetic field sensor can be replaced by at least one inductive sensor.

According to one embodiment, the at least one second magnetic field sensor can be a digital sensor or an analog sensor. The at least one second magnetic field sensor can thus be in the form of a digital or analog single-axis Hall sensor. Such an embodiment has the advantage that depending on the concrete application scenario, at least one suitably designed second magnetic field sensor can be used.

The device can also contain numerous second magnetic field sensors. In this case, each second magnetic field sensor of the numerous second magnetic field sensors can be assigned to the various positions. A second magnetic field sensor can be provided for at least a subgroup of the various positions. In particular, one second magnetic field sensor can be provided for each of the various positions. Such an embodiment has the advantage that operating reliability can be increased, and an error, e.g. in the first magnetic field sensor, can be more reliably detected.

Furthermore, the first magnetic field sensor and the at least one second magnetic field sensor can be spaced apart by a distance corresponding to the distance between two positions of the actuating element. Such an embodiment has the advantage that a movement of the actuating element as well as an error in the magnetic field sensors can be reliably detected.

The first magnetic field sensor can also be located at a standby position of the actuating element. In this case, the at least one second magnetic field sensor can be located at least one displaced position of the actuating element. Such an embodiment has the advantage that a position of the actuating element can be reliably detected, and at least one displaced position other than the standby position can also be redundantly verified by means of the at least one second magnetic field sensor.

The device can also comprise an evaluation device. The evaluation device can be or is connected to the first magnetic field sensor and the at least one second magnetic field sensor for signal transmission. The evaluation device can be configured to evaluate a first sensor signal from the first magnetic field sensor and at least one second sensor signal from the at least one second magnetic field sensor. An evaluation device can be an electric device that processes electrical signals, e.g. sensor signals, and outputs control signals based thereon. The evaluation device can have one or more hardware and/or software interfaces. A hardware interface can be part of an integrated circuit, for example, in which functions of the evaluation device are implemented. The interfaces can also be separate integrated circuits, or composed at least in part of discrete components. A software interface can be a software module on a microcontroller, for example, in addition to other software modules. Such an embodiment has the advantage that a reliable and precise determination of a position can be obtained.

The evaluation device can be configured to compare the first sensor signal with the at least one second sensor signal in order to detect an error in the first magnetic field sensor or the at least one second magnetic field sensor. Such an embodiment has the advantage that a reliable error detection is obtained.

A system for effecting a shifting procedure in a transmission of a vehicle comprises at least the following features:

an embodiment of the aforementioned device; and

the actuating element, which contains the magnetic transmitter, wherein the first magnetic field sensor and the at least one second magnetic field sensor in the device can be or are magnetically coupled to the magnetic transmitter.

An embodiment of the aforementioned device can be advantageously implemented or used in conjunction with the system in order to determine the position of the actuating element.

According to one embodiment, the actuating element can be a gearshift lever or a rotary shifter. With an actuating element in the form of a gearshift lever, at least some of the various positions can be located along an axis. With an actuating element in the form of a rotary shifter, at least some of the various positions can be located along a circular track around an axis. Such an embodiment has the advantage that an inexpensive and reliable position determination can be obtained using either a gearshift lever or a rotary shifter.

A method for determining a position of an actuating element for a transmission in a vehicle, wherein the actuating element contains a magnetic transmitter, wherein the actuating element can be moved by a driver of the vehicle to various positions in order to effect shifting procedures in the transmission, comprises at least the following steps:

inputting a first sensor signal from an interface to a first magnetic field sensor in the form of a 3D Hall sensor on a semiconductor chip, wherein the first magnetic field sensor is configured to detect each position of the actuating element using the magnetic transmitter, and at least one second sensor signal from an interface to at least one second magnetic field sensor in the form of a single-axis Hall sensor, wherein the at least one second magnetic field sensor is configured to detect at least one position of the actuating element using the magnetic transmitter; and

evaluating the first sensor signal and the at least one second sensor signal in order to determine the position of the actuating element.

The method can be executed in conjunction with an embodiment of the aforementioned system, and/or using an embodiment of the aforementioned device.

A computer program containing program code, that can be stored on a machine-readable medium, such as a semiconductor memory, a hard drive memory, or an optical memory, and used for executing the method according to any of the embodiments described above, when the program is executed on a computer or evaluation device, is also advantageous.

In the following description of preferred exemplary embodiments of the present invention, the same or similar reference symbols are used for the elements shown in the various figures that have similar functions, wherein the descriptions of these elements shall not be repeated.

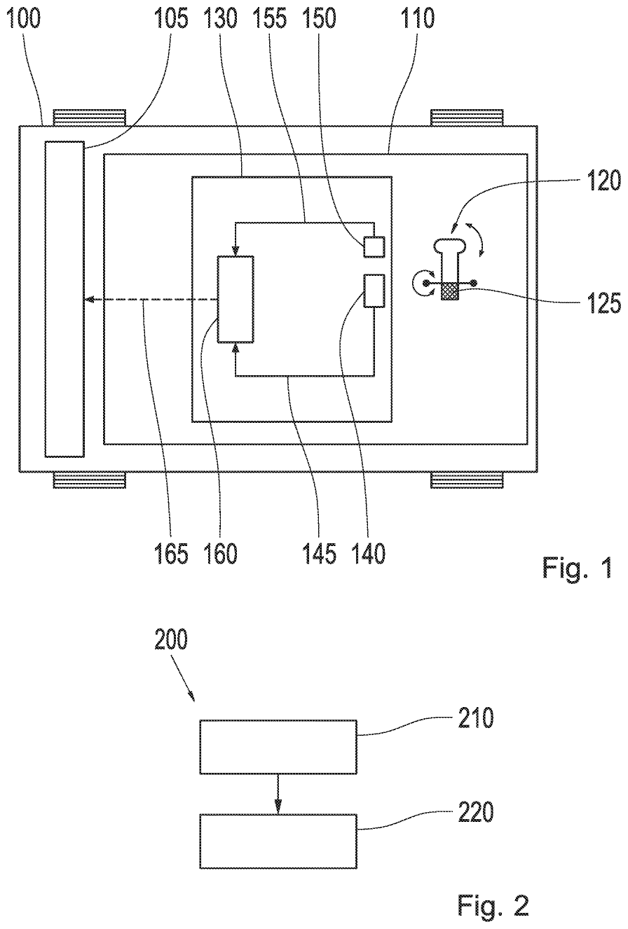

FIG. 1 shows a schematic illustration of a system 110 according to an exemplary embodiment of the present invention, in a vehicle 100. The vehicle 100 is a motor vehicle, for example, in particular a land vehicle or water vehicle, e.g. a passenger car.

The vehicle 100 has a transmission 105 for a drive in the vehicle 100. The system 110 is configured to effect shifting procedures in the transmission 105. The transmission 105 is, e.g., an automatic transmission. The system 110 contains an actuating element 120 with a magnetic transmitter 125 and a device 130 for determining a position of the actuating element 120.

The actuating element 120 can be moved by a driver of the vehicle 100 to different positions in order to effect shifting procedures in the transmission 105. According to the exemplary embodiment of the present invention shown in FIG. 1, the actuating element 120 is in the form of a gearshift lever. According to another exemplary embodiment, the actuating element 120 can be a rotary shifter.

The device 130 contains a first magnetic field sensor 140 and at least one second magnetic field sensor 150. According to the exemplary embodiment of the present invention shown in FIG. 1, the device 130 contains the first magnetic field sensor 140, and just one second magnetic field sensor 150, by way of example.

The first magnetic field sensor 140 and the at least one second magnetic field sensor 150 in the device 130 are coupled magnetically to the magnetic transmitter 125. At least the first magnetic field sensor 140 and the second magnetic field sensor 150 in the device 130 are adjacent to the magnetic transmitter 125 in the actuating element 120.

The first magnetic field sensor 140 is in the form of a 3D Hall sensor on a semiconductor chip. The first magnetic field sensor 140 is configured to detect each position of the actuating element 120 using the magnetic transmitter 125. The second magnetic field sensor 150 is in the form of a single-axis Hall sensor. The second magnetic field transmitter 150 is configured to detect a position of the actuating element 120 using the magnetic transmitter 125.

According to the exemplary embodiment of the present invention in FIG. 1, the device 130 also contains an optional evaluation device 160. The evaluation device 160 is coupled to the first magnetic field sensor 140 and the second magnetic field sensor 150 for signal transmission. The evaluation device 160 is configured to evaluate, or input and evaluate, a first sensor signal 145 of the first magnetic field sensor 140 and a second sensor signal 155 of the second magnetic field sensor 150. The evaluation device 160 is configured to generate and/or output a determination signal 165. The determination signal 165 represents a position of the actuating element 120 determined using the evaluated sensor signals 145, 155. In particular, the evaluation device 160 is configured to compare the first sensor signal 145 with the second sensor signal 155, in order to detect an error in the first magnetic field sensor 140 or the second magnetic field sensor 150.

The device 130 is thus configured to generate the sensor signals 145, 155, and to generate and output the determination signal 165, which represents the determined position of the actuating element 120, on the basis of the sensor signals 145, 155.

FIG. 2 shows a flow chart for a method 200 for determining a position according to an exemplary embodiment of the present invention. The method 200 can be executed in order to determine a position of an actuating element for a transmission in a vehicle. The method 200 for determining a position can be executed in conjunction with the system shown in FIG. 1, or a similar system, and/or in conjunction with the device shown in FIG. 1, or a similar device. The method 200 can thus be executed in conjunction with an actuating element that contains a magnetic transmitter, wherein the actuating element can be moved by a driver of the vehicle to various positions in order to effect shifting procedures in a transmission.

The method 200 for determining a position comprises at least a step 210 for inputting and a step 220 for evaluating. In the inputting step 210, a first sensor signal from an interface to a first magnetic field sensor and at least on second sensor signal from an interface to at least one second magnetic field sensor are input. The first magnetic field sensor is in the form of a 3D Hall sensor on a semiconductor chip. The first magnetic field sensor is configured to detect each position of the actuating element using the magnetic transmitter. The at least one second magnetic field sensor is configured to detect at least one position of the actuating element using the magnetic transmitter. In the evaluating step 220, the first sensor signal and the at least one second sensor signal are evaluated in order to determine the position of the actuating element.

According to one exemplary embodiment, the method 200 for determining a position can also contain a step for providing or outputting a determination signal, which represents the determined position of the actuating element.

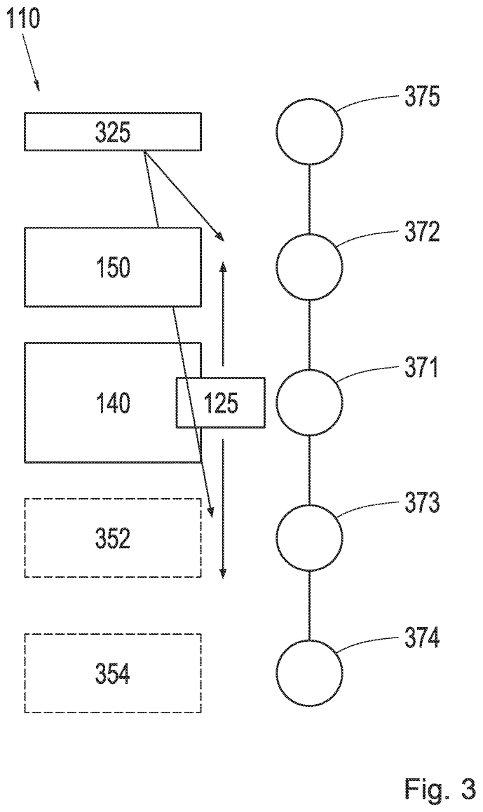

FIG. 3 shows a schematic illustration of a system 110 according to an exemplary embodiment of the present invention. The system 110 in FIG. 3 is similar to the system in FIG. 1. In other words, the system 110 in FIG. 3 corresponds to the system in FIG. 1, with the exception that a movement path 325 or movement axis 325 of the magnetic transmitter 125, two optional further second magnetic field sensors 352, 354, merely by way of example, and five positions 371, 372, 373, 374, 375, also merely by way of example, for the actuating element, or the magnetic transmitter 125, respectively, are also shown in the system 110 in FIG. 3, wherein the actuating element and further features of the device are omitted in the illustration, and the device is not shown explicitly.

The actuating element, or its magnetic transmitter 125 can move along the movement axis 325 between the positions 371, 372, 373, 374, and 375. The actuating element is part of a so-called 2×2 shift-by-wire circuit for detecting a driver's intention. The first magnetic field sensor 140 is located in a first position 371, which represents a resting, or standby position. The second magnetic field sensor 150 is located in a first displaced position 372, or A1. The first magnetic field sensor 140 and the second magnetic field sensor 150 are thus spaced apart according to the exemplary embodiment of the present invention shown in FIG. 3. The spacing corresponds to at least the distance between two positions that can be assumed by the actuating element, in this case the distance between the first position 371, or standby position, and the first displaced position 372.

The two other second magnetic field sensors 352, 354 are located, merely by way of example, at a second displaced position 373, or Bl, and a third displaced position 374, or B2. The standby position 371, or the first position 371, is located between the first displaced position 372 and the second displaced position 373. The second displaced position 373 is located between the standby position 371 and the third displaced position 374. The first displaced position 372 is located between the standby position 371 and a fourth displaced position 375, or A2.

The second magnetic field sensor 150 and the two other second magnetic field sensors 352, 354 are digital sensors. According to an alternative exemplary embodiment, the second magnetic field sensor 150 and the two other second magnetic field sensors 352, 354 are analog sensors.

The device according to the exemplary embodiment of the present invention shown in FIG. 3 thus contains the first magnetic field sensor 140 and three second magnetic field sensors 150, 352, 354. Four of the five positions, i.e. the standby position 371, the first displaced position 372, the second displaced position 373, and the third displaced position 374, thus each have a dedicated magnetic field sensor 140, 150, 352, 354.

Exemplary embodiments and advantages shall now be summarized in reference to FIGS. 1 to 3.

Through the use of a single-die 3D Hall sensor instead of a double-die 3D Hall sensor for the first magnetic field sensor 140, the costs for the device can be reduced by half. By adding one or more, e.g. digital, single-axis Hall sensors for the at least one second magnetic field sensor 150, an intention of the driver to shift driving modes can be detected, even if the 3D hall sensor is defective. In other words, the at least one single-axis Hall sensor monitors the single-die 3D Hall sensor. Errors can thus be detected, and a substitute reaction can be initiated. If there is no error, both values, or the first sensor signal 145 and at least one second sensor signal 155, would change. In the first displaced position 372, for example, the values of the first sensor signal 145 and the second sensor signal 155 should change. Otherwise, there is an error. This can be combined arbitrarily in order to verify specific positions or shifting paths.

Alternatively, instead of an additional digital Hall sensor, another, simpler, analog Hall sensor can be used for the second magnetic field sensor 150 and/or further second magnetic field sensors 352, or 354. Numerous digital single-axis Hall sensors can also be used for the numerous second magnetic field sensors 150, 352, 354.

As a result, the device 130 conforms to the ASIL-B standards, and is also less expensive than a solution containing a double-die 3D Hall sensor serving as the first magnetic field sensor. The savings is approx. 30% with respect to the material costs for the sensor system, wherein this also depends on the number of single-axis Hall sensors, or second magnetic field sensors that are used.

According to one exemplary embodiment, the actuating element 120 can also be a rotary shifter for detecting the position of the driver or the intention of the driver. Optionally, there can be a combination of inductive sensors and digital Hall sensors, or 3D sensors. One advantage of a combination of various solutions is in the reduction in material costs.

The exemplary embodiments shown in the figures and described herein are selected merely by way of example. Different exemplary embodiments can be combined with one another, either in their entirety, or with respect to individual features. An exemplary embodiment can also be supplemented by features of another exemplary embodiment.

Furthermore, method steps according to the invention can be repeated and executed in a sequence other than that described herein.

If an exemplary embodiment comprises an “and/or” conjunctions between a first feature and a second feature, this can be read to mean that the exemplary embodiment according to one embodiment contains both the first feature and the second feature, and according to another embodiment, contains either just the first feature or just the second feature.

### REFERENCE SYMBOLS

100 vehicle
105 transmission
110 system
120 actuating element
125 magnetic transmitter
130 device
140 first magnetic field sensor
145 first sensor signal
150 second magnetic field sensor
155 second sensor signal
160 evaluation device
165 determination signal
200 method for determining a position
210 input step
220 evaluation step
325 movement path or movement axis
352 further second magnetic field sensor
354 further second magnetic field sensor
371 standby position, or first position, or resting position
372 first displaced position, or position A1
373 second displaced position, or position B1
374 third displaced position, or position B2
375 fourth displaced position, or position A2

1. A device for determining a position of an actuating element for a transmission in a vehicle, wherein the actuating element includes a magnetic transmitter, wherein the actuating element can be movcd to is movable between a plurality of positions by a driver of the vehicle to initiate at least one shifting procedure in the transmission, wherein the device comprises:
a first magnetic field sensor that includes a 3D Hall sensor on a semiconductor chip, wherein the first magnetic field sensor is configured to detect the position of the actuating element using the magnetic transmitter; and
at least one second magnetic field sensor that includes a single-axis Hall sensor, wherein the at least one second magnetic field sensor is configured to detect the position of the actuating element using the magnetic transmitter.

2. The device according to claim 1, wherein the at least one second magnetic field sensor includes at least one of a digital sensor and an analog sensor.

3. The device according to claim 1, wherein a plurality of second magnetic field sensors are included, and wherein a single second magnetic field sensor of the plurality of second magnetic field sensors is included for each of the plurality of positions of the actuating element.

4. The device according to claim 1, wherein the first magnetic field sensor and the at least one second magnetic field sensor are spaced apart by at least a distance corresponding to the distance between two positions of the plurality of positions of the actuating element.

5. The device according to claim 1, wherein the first magnetic field sensor is located at a standby position of the actuating element, wherein the at least one second magnetic field sensor is located a distance equal to or greater than the distance between the standby position and at least one other position of the plurality of positions of the actuating element.

6. The device according to claim 1, further comprising an evaluation device, wherein the evaluation device is operatively connected to the first magnetic field sensor and the at least one second magnetic field sensor, and wherein the evaluation device is configured to evaluate a first sensor signal from the first magnetic field sensor and at least one second sensor signal from the at least one second magnetic field sensor.

7. The device according to claim 6, wherein the evaluation device is configured to compare the first sensor signal with the at least one second sensor signal in order to detect an error in the first magnetic field sensor or the at least one second magnetic field sensor.

8. A system comprising:
the device according to claim 1; and
the actuating element.

9. The system according to claim 8, wherein the actuating element includes at least one of a gearshift lever and a rotary shifter.

10. A method for determining a position of an actuating element for a transmission in a vehicle, wherein the actuating element includes a magnetic transmitter, wherein the actuating element is movable between a plurality of positions by a driver of the vehicle to initiate at least one shifting procedure in the transmission, the method comprising:
inputting a first sensor signal from an interface to a first magnetic field sensor, wherein the first magnetic field sensor includes a 3D Hall sensor on a semiconductor chip, wherein the first magnetic field sensor is configured to detect the position of the actuating element using the magnetic transmitter;
inputting at least one second sensor signal from an interface to at least one second magnetic field sensor, wherein the second magnetic field sensor includes a single-axis Hall sensor, wherein the at least one second magnetic field sensor is configured to detect the position of the actuating element using the magnetic transmitter; and
evaluating the first sensor signal and the at least one second sensor signal in order to determine the position of the actuating element.

11. A system, comprising:
an actuating element for initiating a shift of a vehicle transmission, wherein the actuating element comprises a magnetic transmitter, and wherein the actuating element is movable between a plurality of positions;
a 3D Hall sensor coupled to a semiconductor chip, wherein the 3D Hall sensor is configured to detect a position of the actuating element by cooperating with the magnetic transmitter; and
a single-axis Hall sensor, wherein the single-axis Hall sensor is configured to detect the position of the actuating element by cooperating with the magnetic transmitter.

12. The system according to claim 11, wherein the single-axis Hall sensor operates digitally.

13. The system according to claim 11, wherein the single-axis Hall sensor operates in an analog manner.

14. The system according to claim 11, wherein a plurality of second magnetic field sensors are included.

15. The system according to claim 14, wherein a single second magnetic field sensor of the plurality of second magnetic field sensors is included for each of the plurality of positions of the actuating element.

16. The system according to claim 11, wherein the 3D Hall sensor and the single-axis Hall sensor are spaced apart by at least a distance corresponding to the distance between two consecutive positions of a plurality of positions of the actuating element.

17. The system according to claim 11, wherein the 3D Hall sensor is located at a standby position of the actuating element, and wherein the single-axis Hall sensor is located a distance from the 3D Hall Sensor that is equal to or greater than a distance between the standby position and the nearest operation position of the actuating element.

18. The system according to claim 11, further comprising an evaluation device that is operatively connected to each of the 3D Hall sensor and the at least one single-axis Hall sensor.

19. The system according to claim 18, wherein the evaluation device is configured to evaluate each of a first sensor signal from the 3D Hall sensor and a second sensor signal from the single-axis Hall sensor.

20. The system according to claim 19, wherein the evaluation device is configured to compare the first sensor signal with the second sensor signal in order to detect an error.
